(19) United States
(12) Patent Application Publication
(10) Pub. No.: US 2026/0029244 A1
(43) Pub. Date: Jan. 29, 2026

(54) INFORMATION PROCESSING DEVICE, INFORMATION PROCESSING METHOD, AND PROGRAM

(71) Applicant: Nissan Motor Co., Ltd., Yokohama-shi, Kanagawa (JP)

(72) Inventor: Hirofumi INOUE, Kanagawa (JP)

(21) Appl. No.: 18/996,443

(22) PCT Filed: Jul. 12, 2023
(86) PCT No.: PCT/JP2023/025721

§ 371 Date: Jan. 17, 2025

(30) Foreign Application Priority Data
Jul. 22, 2022 (JP) 2022-117391

(51) Int. Cl. G01C 21/36; B60K 35/29

(52) U.S. Cl. CPC G01C 21/3629; B60K 35/29; G01C 21/3605; G01C 21/3655

(57) ABSTRACT

An information processing device includes an information acquisition unit, an output unit and a control unit. The information acquisition unit acquires route guidance information for providing guidance on the route of the vehicle in the facility, facility guidance information for providing guidance on predetermined information on each location in the facility, and character information for outputting a character related to the facility, when the vehicle enters a predetermined range with reference to a facility. The control unit causes the output unit to output the character based on the character information, and causes the output unit to output at least one of route guidance and facility guidance based on the route guidance information and the facility guidance information. The control unit changes an output mode of the character output from the output unit according to the route guidance or the facility guidance output from the output unit.

### TECHNICAL FIELD

The present invention relates to an information processing device, an information processing method, and a program capable of providing guidance on a route of a vehicle.

### BACKGROUND INFORMATION

In the related art, there is a technique for providing guidance on a route of a vehicle. For example, a technique is proposed in which, outside a local route guidance area, route guidance is provided using map data for a navigation system that may be used public, and inside the local route guidance area, route guidance in a specific area that is not included in the map data is provided (for example, see JP2019-534521A).

### SUMMARY

In the related art described above, it is possible to execute route guidance within a specific area inside the local route guidance area. However, it is impossible to provide facility guidance, facility advertisement, and the like in the area. Therefore, there is a possibility that appropriate information corresponding to a facility cannot be provided to a user riding in a vehicle traveling in the facility.

An object of the present invention is to provide more appropriate information corresponding to a facility to a user who rides in a vehicle and arrives at the facility.

An aspect of the present invention is an information processing device capable of providing guidance on a route of a vehicle. The information processing device includes an information acquisition unit configured to acquire, when the vehicle enters a predetermined range with reference to a facility, route guidance information for providing guidance on the route of the vehicle in the facility, facility guidance information for providing guidance on predetermined information on each location in the facility, and character information for outputting a character related to the facility, a storage unit configured to hold the route guidance information, the facility guidance information, and the character information, a positional information acquisition unit configured to acquire positional information on the facility, an output unit configured to output various types of information, and a control unit configured to cause the output unit to output the character based on the character information, and cause the output unit to output at least one of the route guidance and the facility guidance based on the route guidance information, the facility guidance information, and the positional information.

### BRIEF DESCRIPTION OF DRAWINGS

FIG. 1 is a block diagram illustrating a simplified system configuration example of an information processing system.

FIG. 2 is a block diagram illustrating a functional configuration example of an information processing device and a facility server.

FIG. 3 is a simplified diagram illustrating a vehicle moving toward an ABC facility.

FIG. 4 is a diagram illustrating an output example of facility information output from an output unit when the vehicle enters the ABC facility.

FIG. 5 is a diagram illustrating an output example of the facility information output from the output unit when the vehicle enters the ABC facility.

FIG. 6 is a diagram illustrating an output example of the facility information output from the output unit when the vehicle enters the ABC facility.

FIG. 7 is a diagram illustrating an output example of the facility information output from the output unit when the vehicle enters the ABC facility.

FIG. 8 is a diagram illustrating an output example of the facility information output from the output unit when the vehicle enters the ABC facility.

FIG. 9 is a diagram illustrating an output example of the facility information output from the output unit when the vehicle enters the ABC facility.

FIG. 10 is a diagram illustrating an output example of the facility information output from the output unit when the vehicle enters the ABC facility.

FIG. 11 is a flowchart illustrating an example of a facility information output control process in the information processing device.

FIG. 12 is a diagram illustrating an output example of the facility information output from the output unit when the vehicle leaves the ABC facility.

FIG. 13 is a diagram illustrating an output example of the facility information output from the output unit when the vehicle leaves the ABC facility.

FIG. 14 is a diagram illustrating an output example of the facility information output from the output unit when the vehicle leaves the ABC facility.

FIG. 15 is a diagram illustrating an output example of the facility information output from the output unit when the vehicle leaves the ABC facility.

FIG. 16 is a flowchart illustrating an example of the facility information output control process in the information processing device.

FIG. 17 is a block diagram illustrating a functional configuration example of a facility server.

FIG. 18 is a simplified diagram illustrating storage contents in a visit history management DB stored in a storage unit.

FIG. 19 is a diagram illustrating an output example in a case where the facility information is output from the output unit when the vehicle enters the ABC facility.

FIG. 20 is a diagram illustrating an output example in a case where the facility information is output from the output unit when the vehicle enters the ABC facility.

FIG. 21 is a flowchart illustrating an example of the facility information output control process in the information processing device and the facility server.

### DESCRIPTION OF EMBODIMENTS

Hereinafter, embodiments of the present invention will be described with reference to the accompanying drawings.

### Configuration Example of Information Processing System

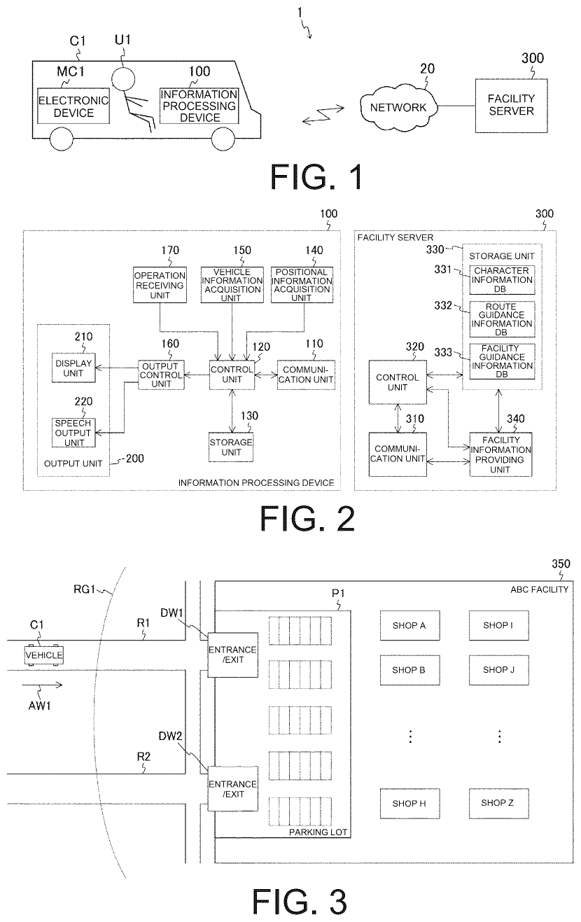

FIG. 1 is a block diagram illustrating a simplified system configuration example of an information processing system 1. The information processing system 1 is a communication system that provides a facility information providing service in which route guidance for providing guidance on a route in an ABC facility 350 (see FIG. 3) and facility guidance for providing guidance on each unit in the ABC facility 350, for example, each of shops A to Z are executed using a character. Although FIG. 1 illustrates an example in which one vehicle C1 is present for ease of description, the present invention is not limited thereto. The information processing system 1 may include two or more vehicles. FIG. 1 illustrates only the facility server 300 that provides facility information related to the ABC facility 350, but the present invention is not limited thereto. In the information processing system 1, the facility server 300 may provide facility information related to another facility, or another facility server that provides facility information related to another facility may be included.

A user U1 is assumed to be a user who owns the vehicle C1. In FIG. 1, an electronic device MC1 is illustrated as a device owned by the user U1 for ease of description, but the present invention is not limited thereto, and a carry-in device for the vehicle C1, or a device that may be worn by the user U1 may be used.

The information processing system 1 includes a plurality of devices connected via a network 20. For example, an information processing device 100, the facility server 300, and the electronic device MC1 are connected via the network 20. Regarding communication among the devices, communication using wired communication or communication using wireless communication is performed. In addition, regarding the communication among the devices, direct communication may be performed among the devices other than the communication via the network 20.

The network 20 is a network such as a public line network or the Internet. Each device constituting the information processing system 1 is connected to the network 20 by either a communication method using wireless communication or a communication method using wired communication, or by both methods.

The vehicle C1 is a vehicle such as an internal combustion engine vehicle, a hybrid vehicle, or an electric vehicle.

The information processing device 100 is an in-vehicle device installed in the vehicle C1, and is a facility information presentation device capable of providing guidance on a route of the vehicle C1. The information processing device 100 outputs facility information related to the ABC facility 350 (see FIG. 3) based on the facility information transmitted from the facility server 300. An output example of the facility information will be described in detail with reference to FIGS. 5 to 10. A functional configuration example of the information processing device 100 will be described in detail with reference to FIG. 2.

The information processing device 100 may be, for example, a touch panel device capable of receiving a user operation in response to a touch operation by the user U1. The information processing device 100 is implemented by, for example, a tablet terminal, a car navigation device, or in-vehicle infotainment (IVI). For example, the information processing device 100 can be installed on a dashboard of the vehicle C1. However, a position where the information processing device 100 is installed is not limited thereto. For example, the information processing device 100 may be installed as a rear monitor above a rear seat of the vehicle C1.

The facility server 300 is an information processing device that executes a facility guidance process for outputting the facility information from the information processing device 100. The installation location of the facility server 300 is not particularly limited, and for example, the facility server 300 is installed in a management center of a company that operates the ABC facility 350. In the present embodiment, the facility server 300 executes the facility guidance process related to the ABC facility 350, but the facility server 300 may execute a facility guidance process related to another facility. A functional configuration example of the facility server 300 will be described in detail with reference to FIG. 2.

The electronic device MC1 is a portable information processing device carried by the user U1, and is, for example, an information processing device such as a smartphone, a tablet terminal, or a portable personal computer. The electronic device MC1 is a device capable of outputting the facility information transmitted from the facility server 300. For example, the electronic device MC1 may display the facility information on a display unit or output the facility information by speech.

### Functional Configuration Example of Information Processing Device and Facility Server

FIG. 2 is a block diagram illustrating a functional configuration example of the information processing device 100 and the facility server 300.

The information processing device 100 includes a communication unit 110, a control unit 120, a storage unit 130, a positional information acquisition unit 140, a vehicle information acquisition unit 150, an output control unit 160, an operation receiving unit 170, and an output unit 200.

Under the control of the control unit 120, the communication unit 110 exchanges various types of information with other devices using at least one of wired communication and wireless communication.

The control unit 120 controls each unit based on various programs stored in the storage unit 130. The control unit 120 is implemented by, for example, a processing circuit such as a central processing unit (CPU). A vehicle electronic control unit (ECU) of the vehicle C1 may be used as the control unit 120, and another control device may be used as the control unit 120.

The storage unit 130 is a storage medium that stores various types of information. For example, the storage unit 130 stores various types of information (for example, control program, map information database (DB), and facility information) necessary for the information processing device 100 to perform various processes. As the storage unit 130, for example, a read only memory (ROM), a random access memory (RAM), a hard disk drive (HDD), a solid state drive (SSD), or a combination thereof may be used. The map information DB stores map information such as road information related to roads necessary for route guidance of the vehicle C1. The map information includes a gradient of a road, an intersection point of the road, the number of lanes of the road, road width information, and undulation information of the road. The map information also includes a road sign indicating a speed limit, one-way traffic, and the like, and a road marking indicating a crosswalk, a carriageway marking, and the like. The map information may also include facility information such as road structures (for example, traffic signal, telephone pole), and buildings.

The positional information acquisition unit 140 acquires positional information related to a position where the vehicle C1 is present, and outputs the acquired positional information to the control unit 120. For example, it can be implemented by a global navigation satellite system (GNSS) receiver that acquires positional information using GNSS. The positional information includes data related to the position such as latitude, longitude, altitude, and the like at the time of receiving a GNSS signal. In addition, the positional information may be acquired by another positional information acquisition method. For example, the positional information may be derived using information from an access point or a base station present in the vicinity of the vehicle C1. In addition, the positional information may be acquired using a beacon.

The positional information acquisition unit 140 also functions as a recognition unit for specifying a specific location in or near the ABC facility 350 (see FIG. 3). For example, the positional information acquisition unit 140 may recognize a specific location by recognizing a marker installed in or near the ABC facility 350. As the marker, short-range communication such as Bluetooth (registered trademark) Low Energy (BLE) or Ultra Wide Band (UWB) may be used, or an image reading marker such as a QR code (registered trademark) may be used. For example, it is possible to recognize a specific location by using wireless communication with a communication device which is installed at the specific location and capable of performing short-range communication. In addition, for example, it is possible to acquire an image of an image reading marker installed at a specific location by a camera, analyze the image, and recognize the specific location.

In addition, a marker capable of acquiring character information may be used. For example, character information may be included in information exchanged using short-range communication. In addition, for example, it is possible to acquire, by a camera, an image of an image reading marker capable of acquiring character information, and analyze the image to acquire the character information. In this manner, by including character information in a marker capable of recognizing a specific location in or near the ABC facility 350, it is possible to include connection information of the facility server 300 (for example, access information and connection method to facility server 300) in addition to recognition of the specific location. Accordingly, when the vehicle C1 enters the ABC facility 350, access from the information processing device 100 to the facility server 300 becomes easy. In this case, for example, by including information related to connection to a communication environment of the ABC facility 350, for example, intranet connection using Wi-Fi, in the character information, connection other than connection via the Internet is also possible.

The vehicle information acquisition unit 150 acquires various types of information related to the vehicle C1, and outputs the acquired vehicle information to the control unit 120. The vehicle information is, for example, a speed of the vehicle C1, or an ON/OFF operation of the vehicle C1. The ON/OFF operation of the vehicle C1 means an ON operation or an OFF operation of a start key related to starting or stopping of the vehicle C1.

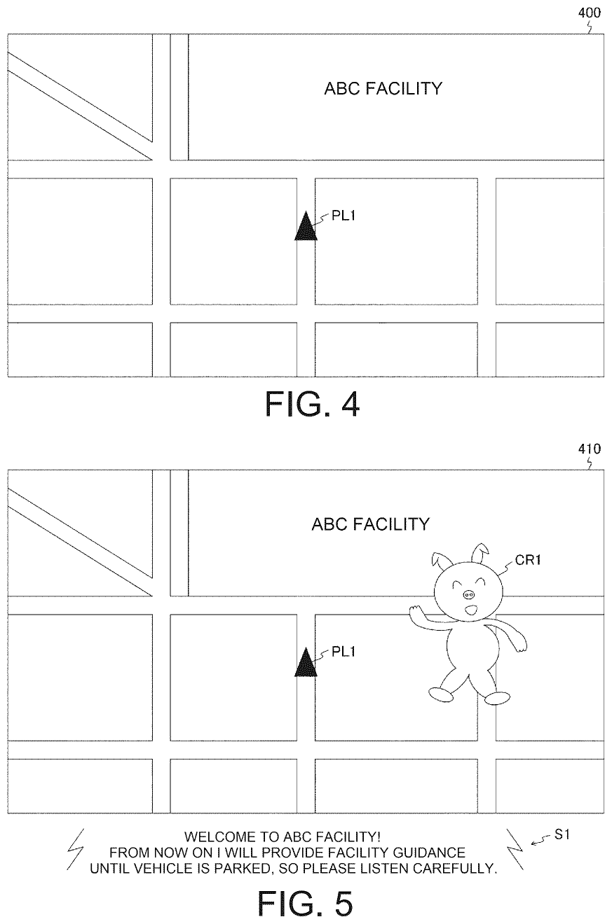

The output control unit 160 executes an output process of causing the output unit 200 to output various types of information under the control of the control unit 120. For example, the output control unit 160 executes display control and drawing control of a display unit 210. For example, the output control unit 160 executes speech output control of a speech output unit 220. Output examples of various types of information output from the output control unit 160 are illustrated in FIGS. 4 to 10 and the like.

The operation receiving unit 170 receives an operation from the user U1 of the vehicle C1, and outputs the received operation content to the control unit 120. The operation receiving unit 170 may include an operation member such as a button or a lever, or an operation member such as a touch panel. In addition, an operation may be received by speech input. The operation receiving unit 170 and the display unit 210 may be integrally configured as a touch panel.

The output unit 200 includes the display unit 210 and the speech output unit 220. The display unit 210 is a display panel that displays various images based on the output process of the output control unit 160. The speech output unit 220 is a speaker that outputs various types of speech based on the output process of the output control unit 160. Although FIG. 2 illustrates an example in which the display unit 210 and the speech output unit 220 are provided in the information processing device 100, a display or a speaker installed in the vehicle C1 may be used as the display unit 210 and the speech output unit 220.

### Functional Configuration Example of Server

The facility server 300 includes a communication unit 310, a control unit 320, a storage unit 330, and a facility information providing unit 340. In the facility server 300, these components are electrically connected via a bus (not illustrated) or the like. A general-purpose computer or a dedicated computer can be used as the facility server 300.

Under the control of the control unit 320, the communication unit 310 exchanges various types of information with other devices using at least one of wired communication and wireless communication.

The control unit 320 controls each unit based on various programs stored in the storage unit 330. The control unit 320 is implemented by, for example, a processing circuit such as CPU.

The storage unit 330 is a storage medium that stores various types of information. For example, the storage unit 330 stores various types of information (for example, control program, character information DB 331, route guidance information DB 332, and facility guidance information DB 333) necessary for the control unit 320 to perform various processes. In addition, the storage unit 330 stores various types of information acquired via the communication unit 310. As the storage unit 330, for example, various storage media such as ROM, RAM, HDD, and SSD can be used.

The character information DB 331 stores character information related to a character to be output from the output unit 200 of the information processing device 100. This character is a character related to the ABC facility 350 or its region. For example, an image character used for advertising the ABC facility 350 or the like or used for creating an image of the ABC facility 350 may be used. In addition, the character is a character capable of executing various appearances, operations, or performances, and can be, for example, a pseudo-biological character. A living body other than an animal, for example, a pseudo-biological plant, or an object other than a living body, may be set as the character. For example, a robot imitating another animal, a robot imitating a living body of a virtual object (for example, face of animation character), or a robot imitating another object (for example, television device or radio device) may be set as the character.

The character information includes, for example, display information for displaying an image of a character and speech information for outputting speech of the character. The display information is, for example, information for performing movement of the character (for example, movement at the time of providing guidance) or performance of the character. In addition, the speech information is, for example, Text-to-speech (TTS). As the character information, for example, at least one of model data of a character, display information related to a display mode of the model data, operation instruction information related to an operation of the model data, and speech information related to speech of the model data may be used. The model data of the character is, for example, 3D data or 2D data. The display information related to the display mode of the model data is, for example, an image for displaying the model data, or a costume image of the model data. The speech information related to the speech of the model data is, for example, the speech of the model data, or the speech pattern of the model data. The character described in the present embodiment may be referred to as an avatar or the like.

The route guidance information DB 332 stores route guidance information for providing guidance on a parking lot Pl of the ABC facility 350. The route guidance information is, for example, map information in the ABC facility 350, route information indicating a movement route of a vehicle in the parking lot P1, a configuration image for displaying an overall configuration of the parking lot P1, and parking presence/absence information indicating presence or absence of parking in each parking space. It is possible to provide a vehicle entering the ABC facility 350 with guidance to a vacant space of the parking lot P1 based on the parking presence/absence information. The presence or absence of parking in each parking space may be detected by a sensor or the like installed in each parking space. Alternatively, the presence or absence of parking in each parking space may be detected based on the positional information acquired by the positional information acquisition unit of each vehicle. The route guidance information DB 332 may include traffic jam information around the parking lot P1 and traffic jam information of the parking lot P1.

The facility guidance information DB 333 stores facility guidance information for providing guidance on the ABC facility 350 output from the output unit 200 of the information processing device 100. The facility guidance information is information for providing guidance on predetermined information regarding each location in the ABC facility 350, and is, for example, special information related to the ABC facility 350, or special information related to a shop in the ABC facility 350.

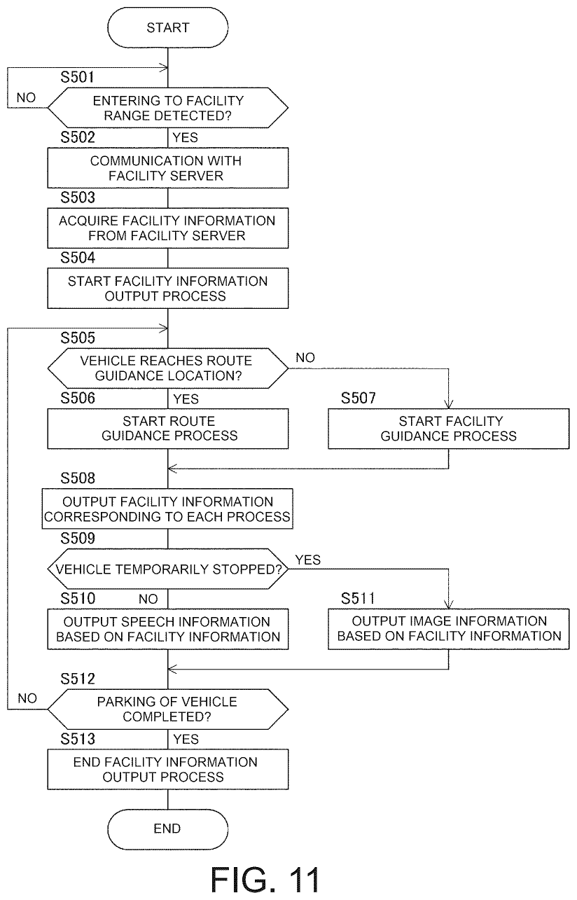

The facility information providing unit 340 executes, under the control of the control unit 320, a providing process of providing facility information to the information processing device 100 of the vehicle C1 entering the ABC facility 350 (see FIG. 3). The facility information providing unit 340 is implemented by, for example, a processing circuit such as CPU. A timing when the facility information is provided to the information processing device 100 of the vehicle C1 entering the ABC facility 350 will be described in detail with reference to FIGS. 3 and 11.

### Example of Vehicle Entering Facility

FIG. 3 is a simplified diagram illustrating the vehicle C1 moving toward the ABC facility 350. FIG. 3 illustrates an example of the ABC facility 350 in which two entrances/exits DW1 and DW2 are provided as the entrance/exit of the vehicle C1. It is assumed that the entrance/exit DW1 may mainly allow entry and exit through a road R1, and the entrance/exit DW2 may mainly allow entry and exit through a road R2.

It is also assumed that the ABC facility 350 is a complex facility in which the shops A to Z are installed. It is also assumed that the parking lot P1 is installed in the ABC facility 350. In FIG. 3, the ABC facility 350 in which a plurality of shops are installed is described as an example, but the present invention is similarly applicable to other facilities in which a parking lot is installed, for example, a facility in which only one shop is installed or facilities such as a theme park, various shopping centers, a castle, a public institution including one or a plurality of buildings, or a park including one or a plurality of buildings.

FIG. 3 illustrates an example when the vehicle C1 is toward the ABC facility 350. That is, an example when the vehicle C1 travels on the road R1 in an arrow AW1 direction is illustrated. In this case, the vehicle C1 enters the parking lot P1 from the entrance/exit DW1.

Here, a predetermined range RG1 indicated by a dotted line indicates a reference range when the facility information is transmitted to each vehicle entering the ABC facility 350. The predetermined range RG1 may be, for example, a range of a circle having a predetermined radius with reference to a center position of the ABC facility 350. The predetermined range RG1 may be set based on, for example, a distance between the vehicle C1 and the ABC facility 350, or a radio wave intensity at which the information processing device 100 of the vehicle C1 and the facility server 300 may perform wireless communication.

FIG. 3 illustrates an example in which the predetermined range RG1 is provided on a front side of the entrances/exits DW1 and DW2 of the ABC facility 350, that is, on a side opposite to the ABC facility 350. However, a position where the facility information is transmitted to each vehicle entering the ABC facility 350 may be another position outside the ABC facility 350, may be the entrance/exit DW1 or DW2, or may be within the ABC facility 350.

The facility information transmitted from the facility server 300 to the vehicle C1 includes the route guidance information, the facility guidance information, and the character information. The route guidance information is information for providing guidance on a route of the vehicle C1 in the ABC facility 350, for example, a route of the parking lot P1. The facility guidance information is information for providing guidance on predetermined information on each location in the ABC facility 350. In other words, the facility guidance information is information for providing guidance on each location where a person may go in the ABC facility 350, for example, shop A to shop Z. The character information is information for outputting the character related to the ABC facility 350. These pieces of information may be simultaneously transmitted from the facility server 300 to the vehicle C1, or may be sequentially transmitted from the facility server 300 to the vehicle C1. Each piece of information output from the output unit 200 based on the above information will be described in detail with reference to FIGS. 5 to 10 and the like.

In FIG. 3, since the predetermined range RG1 is provided on the front side of the entrance/exit DW1 and DW2 of the ABC facility 350, there is a possibility that the facility information is transmitted to a vehicle passing through the vicinity of the ABC facility 350 without entering the ABC facility 350. That is, it is possible to provide the facility information related to the ABC facility 350 to a vehicle passing through the vicinity of the ABC facility 350. For example, by providing advertisement information related to the ABC facility 350 to a vehicle passing through the vicinity of the ABC facility 350, it is possible to provide inducement information for a user of the vehicle to go to the ABC facility 350.

For example, in a case where the vehicle passing through the vicinity of the ABC facility 350 does not enter the ABC facility 350 when facility information is transmitted to the vehicle, the facility information is erased after a predetermined time elapses. In such a case, output of guidance information such as “please come to ABC facility next time”, output of advertisement information of the ABC facility, and the like may be executed before the facility information is erased. Whether the vehicle enters the ABC facility 350 may be determined based on the positional information acquired by the positional information acquisition unit 140 of the vehicle.

### Output Example of Facility Information

FIGS. 4 to 10 are diagrams illustrating output examples of the facility information output from the output unit 200 when the vehicle C1 enters the ABC facility 350. FIG. 4 illustrates a display screen 400 on which a current location sign PL1 indicating a current location of the vehicle C1 is superimposed and displayed on a map within a predetermined range with reference to the current location of the vehicle C1. FIG. 4 illustrates an example when the vehicle C1 is traveling on the road R1 toward the entrance/exit DW1 of the ABC facility 350. In this manner, in a case where the vehicle C1 travels on the road R1 toward the entrance/exit DW1 and enters the predetermined range RG1, the information processing device 100 of the vehicle C1 starts communication with the facility server 300. Then, the information processing device 100 receives the facility information from the facility server 300.

### Output Example of Facility Information when Vehicle Enters ABC Facility

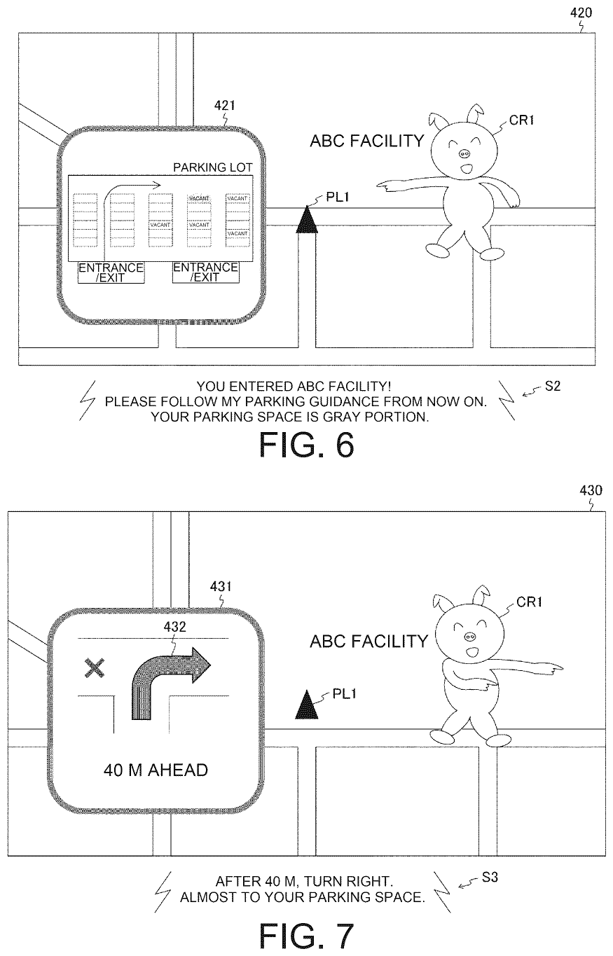

FIG. 5 illustrates a display screen 410 on which a character image CR1 is superimposed and displayed on the display screen 400 illustrated in FIG. 4, and speech information S1. The character image CR1 is an image of the character related to the ABC facility 350. The speech information S1 is speech that is output as if the character image CR1 is uttering. The character image CR1 is displayed based on the character information received from the facility server 300. The speech information S1 is output based on the character information received from the facility server 300. The character image CR1 and speech information S2 to S6, S10 to S13, S20, and S21 illustrated in FIGS. 6 to 10 and the like are also similarly output based on the character information.

Although FIGS. 5 to 10 illustrate examples in which the character image CR1 is displayed, only the speech information of the character may be output without displaying the character image CR1 while the vehicle C1 is traveling. In this case, when the vehicle C1 is stopped, it is possible to display the character image CR1 and output the speech information of the character. This example will be described in detail with reference to FIG. 11.

FIGS. 5 to 10 illustrate examples in which various images based on the facility information transmitted from the facility server 300 are displayed on a map within a predetermined range with reference to the current location of the vehicle C1. However, only various images based on the facility information may be displayed on the display unit 210 without superimposing and displaying, on the map, various images based on the facility information. In addition to other displays, various images based on the facility information may be displayed on the display unit 210.

In this manner, when the vehicle C1 enters the predetermined range RG1 and the information processing device 100 receives the facility information from the facility server 300, the information processing device 100 causes the output unit 200 to output each piece of information related to the ABC facility 350 based on the facility information.

### Output Example of Facility Information while Vehicle is Traveling

FIG. 6 illustrates, together with the character image CR1, a display screen 420 on which a guidance display area 421 for providing guidance on the route of the parking lot P1 of the ABC facility 350 is superimposed and displayed on the map, and the speech information S2.

In the guidance display area 421, the entire configuration and the route of the parking lot P1 of the ABC facility 350, presence or absence of parking in each parking space, and the like are displayed. Each piece of information in the guidance display area 421 is displayed based on the route guidance information received from the facility server 300. Each piece of information in a guidance display area 431 illustrated in FIG. 7, an entrance/exit selection area 631 illustrated in FIG. 15, and a guidance display area 761 illustrated in FIG. 20 is similarly output based on the route guidance information.

As illustrated in FIG. 6, it is possible to manage and provide guidance on the parking space of the vehicle C1 on a facility server 300 side. Accordingly, the user U1 of the vehicle C1 may park the vehicle C1 in the parking lot P1 of the ABC facility 350 without becoming lost. FIG. 6 illustrates an example in which the vehicle C1 is provided with guidance to a vacant space using the guidance display area 421 and the speech information S2, but the present invention is not limited thereto. For example, in the guidance display area 421, the presence or absence of parking in each parking space may be highlighted together with the entire configuration and the route of the parking lot P1, so that the user U1 of the vehicle C1 can easily check the vacant space.

FIG. 6 illustrates an example when the parking lot P1 exists on a plane. However, in the case of a stereoscopic parking lot, the parking lot on each floor may be stereoscopically displayed, or the parking lot on each floor may be displayed for each floor.

In this manner, the facility server 300 may provide the vehicle C1 entering the ABC facility 350 with guidance to a vacant space of the parking lot P1. Accordingly, it is possible to reduce the number of guide persons to be placed in the parking lot P1 of the ABC facility 350.

The character image CR1 may be caused to execute an operation of a guide person of the parking lot P1 providing the vehicle C1 with guidance to a vacant space of the parking lot P1. In this case, guidance to a vacant space may be executed together with the speech information. That is, by a character providing guidance on which parking space is vacant, a user who attaches to the character may follow the instruction.

FIG. 7 illustrates, together with the character image CR1, a display screen 430 on which the guidance display area 431 for providing guidance on a route to a vacant space in the parking lot P1 is superimposed and displayed on a map, and the speech information S3.

In the guidance display area 431, guidance information for providing guidance on the vehicle C1 to a vacant space of the parking lot P1, for example, an arrow sign 432 and a numerical value (40 m ahead) indicating a distance are displayed. Another output mode may be adopted. For example, the parking space of a guidance destination may be displayed by characters such as “turn right at the next corner”, or speech information corresponding to the characters may be output.

The control unit 120 may acquire the position of the vehicle C1 in the parking lot P1 based on the positional information acquired by the positional information acquisition unit 140. The route guidance information includes specific guidance information, for example, positional information related to a route guidance location where the arrow sign 432 is displayed. For example, the control unit 120 causes the display unit 210 to display the guidance display area 431 and causes the speech output unit 220 to output the speech information S3 at a timing when the vehicle C1 reaches the route guidance location where the arrow sign 432 is displayed. While the vehicle C1 is traveling, the display of the character image CR1 may be omitted.

FIG. 7 illustrates an example when the parking lot P1 exists on a plane. However, in the case of a stereoscopic parking lot, a parking space of a guidance destination may be displayed by characters such as “travel toward 305 of A2 on the fourth floor”, or speech information corresponding to the characters may be output.

### Output Example of Facility Information when Vehicle is Stopped

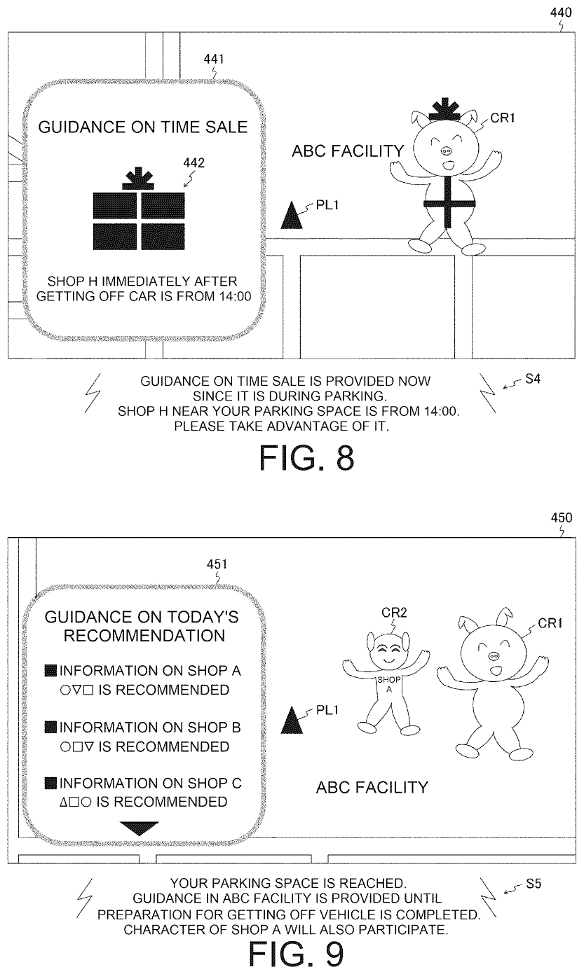

FIG. 8 illustrates, together with the character image CR1, a display screen 440 on which a guidance display area 441 for providing guidance on events and the like of each of the shops A to Z in the ABC facility 350 is superimposed and displayed on a map, and the speech information S4. FIG. 8 illustrates an example in which the appearance of the character image CR1, for example, the costume or the hat is changed according to the content of the guidance display area 441.

In the guidance display area 441, guidance information for providing guidance on time-sale of the shop H of the ABC facility 350, for example, a message or a guidance sign (present box) 442 is displayed.

The control unit 120 may grasp whether the vehicle C1 is traveling or stopped based on the vehicle information acquired by the vehicle information acquisition unit 150. For example, when the parking lot P1 is congested, or when a vehicle in front of the vehicle C1 performs a parking operation, it is assumed that the vehicle C1 is stopped. When the vehicle C1 is stopped, information other than driving, for example, guidance information such as an advertisement of the ABC facility 350, may be provided to the user U1 of the vehicle C1. Specifically, when the vehicle C1 is stopped, the control unit 120 causes the display unit 210 to display the guidance display area 441 and causes the speech output unit 220 to output the speech information S4. When the vehicle C1 is stopped, the character image CR1 may be displayed with a performance with a movement.

### Output Example of Facility Information After Vehicle Arrives at Parking Space

FIG. 9 illustrates a display screen 450 on which a character image CR2 of the shop A is displayed together with the character image CR1, and a guidance display area 451 for providing guidance on advertisements and the like of the shops A to Z in the ABC facility 350 is superimposed and displayed on a map, and the speech information S5. FIG. 9 illustrates an example in which appearances of the character images CR1 and CR2 are changed according to the content of the guidance display area 451. For example, the appearances of the character images CR1 and CR2 can be changed to a pose with arms up in the air.

For example, when guidance on event information or the advertisements of the shops A to Z is provided, it is possible to use a character participating in the event or a character of an advertised shop. In this case, it is conceivable to provide guidance by causing another character or a plurality of characters to appear together with the character of the ABC facility 350. In the example illustrated in FIG. 9, it is possible to provide guidance on the shop A by causing the character image CR2 of the shop A to appear together with the character image CR1.

In the guidance display area 451, guidance information for providing guidance on today's recommendation of each shop of the ABC facility 350, for example, an advertisement of each shop, is displayed. The characters of the shops of which the advertisements are output in the guidance display area 451 may be caused to sequentially appear together with the character image CR1.

The control unit 120 may grasp whether the vehicle C1 arrives at the parking space based on the positional information acquired by the positional information acquisition unit 140 and the vehicle information acquired by the vehicle information acquisition unit 150. For example, it is possible to grasp that the vehicle C1 moves to the position of the vacant space of the route guidance information transmitted from the facility server 300 based on the positional information acquired by the positional information acquisition unit 140. After the vehicle C1 moves to the position of the vacant space, it is possible to grasp that the vehicle C1 is parked based on the vehicle information acquired by the vehicle information acquisition unit 150. When the vehicle C1 is stopped, information other than driving, for example, guidance information such as an advertisement of the ABC facility 350, may be provided to the user U1 of the vehicle C1. Specifically, when the vehicle C1 is parked, the control unit 120 causes the display unit 210 to display the guidance display area 451 and causes the speech output unit 220 to output the speech information S5. When the vehicle C1 is parked, the character image CR1 may be displayed with a performance with a movement.

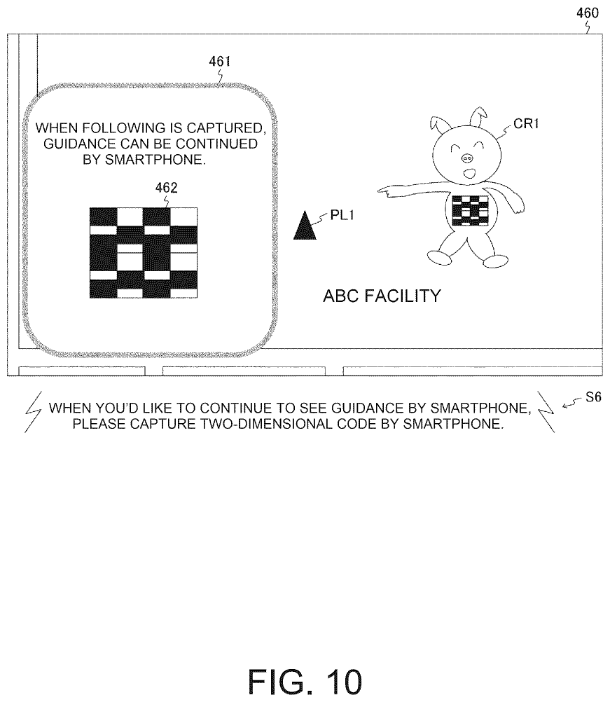

FIG. 10 illustrates, together with the character image CR1, a display screen 460 on which a guidance display area 461 for providing guidance on an operation for continuing provision of the facility guidance information illustrated in FIG. 8, FIG. 9, and the like by the electronic device MC1 possessed by the user U1 is superimposed and displayed on a map, and the speech information S6. FIG. 10 illustrates an example in which the appearance of the character image CR1 is changed according to the content of the guidance display area 461. For example, an image reading marker such as a marker of a two-dimensional code or the like can be displayed on the abdomen of the character image CR1.

In the guidance display area 461, an image reading marker 462 for acquiring predetermined information including connection information (for example, access information and connection method to facility server 300) of the facility server 300 is displayed.

As in the example illustrated in FIG. 9, the control unit 120 may recognize whether the vehicle C1 arrives at the parking space. Here, when the vehicle C1 arrives at the parking space, it is possible to provide the user U1 of the vehicle C1 with guidance indicating that it is possible to provide the facility guidance information such as an advertisement of the ABC facility 350 even after the user U1 gets off the vehicle C1. Specifically, when the vehicle C1 arrives at the parking space, the control unit 120 causes the display unit 210 to display the guidance display area 461 and causes the speech output unit 220 to output the speech information S6. In this case, the user U1 of the vehicle C1 captures the image reading marker 462 using a camera of the electronic device MC1 and performs a predetermined operation, so that communication between the electronic device MC1 and the facility server 300 is enabled, and the facility information is transmitted from the facility server 300 to the electronic device MC1. A known technique may be adopted for each process of the electronic device MC1.

In this manner, various types of control such as contents and providing method of the facility guidance and the route guidance output from the information processing device 100 are executed according to the position of the vehicle C1 in the ABC facility 350, the traveling state of the vehicle C1, and the like.

It is also possible to change only the costume without changing the model data of the character. In addition, it is also possible to cause another piece of model data to wear the costume of the ABC facility 350. For example, it is possible to cause the character of the vehicle C1 to wear the costume of the ABC facility 350 by using a 3D character technology. For example, when the character of the vehicle C1 is a rabbit, it is possible to cause the rabbit to wear the costume of the ABC facility 350. In this manner, it is possible to provide guidance by selectively using a character dedicated to a facility, a character owned by a vehicle, a character in a region, and the like according to the guidance information.

In this manner, in the present embodiment, various levels of information are provided as the character information, so that it is possible to change the character information to be used on a user U1 side of the vehicle C1 as necessary. For example, the character of the ABC facility 350 can provide all the guidance in the ABC facility 350. In addition, when an original character is present on the vehicle C1 side, it is possible to select two-dimensional character display, guidance display with a still image, or the like from a 3D character with a movement according to the guidance on the ABC facility 350 by causing the character to wear the costume for the ABC facility 350 or the performance or setting of the device on the vehicle C1 side.

Accordingly, as information output in the vehicle C1, normal guidance or guidance using the original character of the vehicle C1 may be provided. In addition, regarding the route guidance in the ABC facility 350 and the facility guidance on the ABC facility 350, guidance using character information for the ABC facility 350 is possible. In addition, at the time of providing guidance on an event, shop information in a facility, or the like, it is possible to perform guidance using character information related to the event and character information unique to the shop. Accordingly, it is possible to provide guidance for easily understanding the type and relevance of information.

### Operation Example of Information Processing Device

FIG. 11 is a flowchart illustrating an example of a facility information output control process in the information processing device 100. The output control process is executed based on a program stored in the storage unit 130. The output control process is always executed in each control cycle. The output control process will be described with reference to FIGS. 1 to 10 as appropriate.

In step S501, the control unit 120 determines, based on the positional information acquired by the positional information acquisition unit 140, whether the vehicle C1 enters the predetermined range RG1 (see FIG. 3) with reference to the ABC facility 350. When the vehicle C1 enters the predetermined range RG1, the process proceeds to step S502. On the other hand, when the vehicle C1 does not enter the predetermined range RG1, monitoring is continued.

In step S502, the control unit 120 executes communication with the facility server 300. In this communication, various types of information are exchanged.

For example, it is assumed that the information processing device 100 is a car navigation device. In this case, the map information DB is stored in the storage unit 130 of the information processing device 100. Here, it is conceivable that the positional information (for example, latitude and longitude) of the ABC facility 350 and the predetermined range RG1 and the connection information of the facility server 300 (for example, including access information and connection method to facility server 300) are associated and stored in the map information DB. In this case, the control unit 120 may determine whether the vehicle C1 enters the predetermined range RG1 by comparing the positional information acquired by the positional information acquisition unit 140 with the predetermined range RG1 stored in the map information DB. When it is determined that the vehicle C1 enters the predetermined range RG1, the control unit 120 may acquire the connection information of the ABC facility 350 associated with the predetermined range RG1 and connect to the facility server 300 based on the connection information. The access information to the facility server 300 may be, for example, a uniform resource locator (URL) or connection information of Wi-Fi.

For example, the connection information of the facility server 300 may be provided from the ABC facility 350 side to the vehicle C1. In this case, it is conceivable that an image reading marker capable of reading the connection information of the facility server 300 is installed in the vicinity of the ABC facility 350, for example, in the vicinity of the predetermined range RG1 along the roads R1 and R2. When the vehicle C1 enters the predetermined range RG1, the camera of the vehicle C1 captures the image reading marker, and the control unit 120 acquires the connection information of the facility server 300. Accordingly, the control unit 120 may connect to the facility server 300 based on the connection information of the facility server 300. Communication with the facility server 300 may be local communication. The subsequent exchange between the information processing device 100 and the facility server 300 is executed by a normal communication process. In addition to installing an image reading marker or the like in the vicinity of the ABC facility 350, the control unit 120 may acquire the connection information of the facility server 300 using the short-range communication such as BLE or UWB as described above.

In step S503, the control unit 120 acquires, from the facility server 300, facility information such as route guidance information, facility guidance information, and character information. The route guidance information, the facility guidance information, and the character information may be acquired simultaneously as the facility information or may be acquired sequentially. The control unit 120 stores the received information in the storage unit 130.

The information stored in the storage unit 130, that is, the route guidance information, the facility guidance information, and the character information, is erased at a predetermined timing. The predetermined timing is, for example, a timing when a predetermined time elapses from a reception time received from the facility server 300, a timing when an OFF operation of the vehicle C1 is performed, or a timing when the vehicle C1 leaves the ABC facility 350. The predetermined time may be, for example, about several hours.

The facility information (route guidance information, facility guidance information, and character information) stored in the storage unit 130 may be stored for a long period, for example, about one month. In this case, at a timing when the vehicle C1 goes to the ABC facility 350 within the period (about one month), the control unit 120 may obtain a difference between the facility information stored in the storage unit 130 and the newly acquired facility information and newly store only the facility information that is the difference in the storage unit 130. The control unit 120 may extract facility information that is acquired from the facility server 300 in the past and already becomes an output target, and preferentially set facility information other than the extracted facility information as an output target.

However, it is preferable that information having a time limit such as event information is erased when the time limit is reached. The number of times the vehicle C1 goes to the ABC facility 350 may be stored in association with the facility information stored in the storage unit 130. The number of times may be provided to the facility server 300 in the communication process in step S502.

In step S504, the control unit 120 starts an output process from the output unit 200 based on the facility information acquired from the facility server 300. For example, as illustrated in FIG. 5, display of the character image CR1 and output of the speech information S1 are executed. Only one of these outputs may be executed.

In step S505, the control unit 120 determines whether the vehicle C1 reaches the route guidance location based on the positional information acquired by the positional information acquisition unit 140. The route guidance location means, for example, a location where the vehicle C1 turns right or left (or location in the vicinity of right or left turn location) or a location where some route guidance is required. The control unit 120 may determine that the vehicle C1 reaches the route guidance location based on, for example, positional information acquired using a GNSS device or the like. In addition, the control unit 120 may determine that the vehicle C1 reaches the route guidance location, for example, using an image acquired by capturing an image reading marker installed at the route guidance location (or in the vicinity of route guidance location) with the camera of the vehicle C1.

When the vehicle C1 travels straight, when the vehicle C1 is stopped due to traffic congestion, when the vehicle C1 is stopped while a vehicle in front of the vehicle C1 is executing the parking operation, or the like, the route guidance is unnecessary, and thus it is determined that the vehicle C1 does not reach the route guidance location. When the vehicle C1 reaches the route guidance location, the process proceeds to step S506. On the other hand, when the vehicle C1 does not reach the route guidance location, the process proceeds to step S507.

In step S506, the control unit 120 starts a route guidance process for providing guidance on a route in the ABC facility 350. For example, as illustrated in FIGS. 6 and 7, the display screens 420 and 430 for providing route guidance are displayed on the display unit 210, and the speech information S2 and S3 are output from the speech output unit 220.

In step S507, the control unit 120 starts a facility guidance process of providing guidance on each unit in the ABC facility 350. For example, as illustrated in FIG. 8, the display screen 440 for providing facility guidance is displayed on the display unit 210, and the speech information S4 is output from the speech output unit 220.

In step S507, new information or information with strong temporal restriction may be preferentially output to the user U1 of the vehicle C1. For example, when the facility information is stored in the storage unit 130 for a long period of time, the control unit 120 may extract facility guidance information that already becomes an output target after being acquired from the facility server 300, and preferentially set facility guidance information other than the extracted facility guidance information as an output target. In addition, the control unit 120 may preferentially output event information or the like of the day.

Various contents may be considered as contents of the facility guidance information. For example, in addition to the event information and the advertisement of each shop described above, shop information in the ABC facility 350, store information regarding the ABC facility 350, or store information regarding the character of the ABC facility 350 itself, may be provided as the facility guidance. The store information regarding the ABC facility 350 is deep knowledge, trivia, or the like related to the ABC facility 350. The store information regarding the character itself of the ABC facility 350 is deep knowledge, trivia, or the like related to the character. Each piece of the store information is provided to the user U1 who frequently uses the ABC facility 350 when the facility guidance information as an output target decreases. Instead of the store information, speech information set in advance on the ABC facility 350 side, for example, general speech, recent speech, speech unrelated to the facility, or speech for time wasting may be output. In addition, weather of an area where the ABC facility 350 exists and news of the area may be provided as the facility guidance. The store information and the preset speech information may be stored in the facility guidance information DB 333 and used. Weather in an area, news in an area, and the like may be acquired from another device, for example, a weather information providing server and a news providing server via a predetermined network such as the Internet.

In step S508, the control unit 120 causes the output unit 200 to output facility information corresponding to each process. In this case, the control unit 120 may change the character information at the time of executing the route guidance process and the character information at the time of executing the facility guidance process, and use the character image or the speech of the character corresponding to the guidance process. That is, the character to be used or a part of the character information may be changed according to the information to be guided.

In this manner, guidance on each shop in the ABC facility 350, the parking lot P1, and the like is started based on the facility information acquired from the facility server 300 and the position of the vehicle C1. For example, at a timing when the vehicle C1 turns right or left, route guidance on the parking lot P1 is executed. On the other hand, at a timing during the route guidance on the parking lot P1, facility guidance on each shop or the like in the ABC facility 350 is executed. In this manner, when the vehicle C1 does not turn right or left, the facility guidance on each shop or the like in the ABC facility 350 may be continuously executed. The case where the vehicle C1 does not turn right or left is assumed to be, for example, a case where the vehicle C1 continues to travel straight, or a case where the vehicle C1 goes round and round in a stereoscopic parking lot.

Here, when there are a plurality of vacant spaces in the parking lot P1, the route guidance on the parking lot P1 is often necessary. On the other hand, when the route in the parking lot P1 is only straight ahead, when it is unnecessary to get lost in the parking lot P1, when the user U1 can freely stop the vehicle in a vacant space, or the like, the route guidance on the parking lot P1 may be unnecessary. In such a case, only the guidance that the user U1 may stop the vehicle in a vacant space desired by the user U1 in the parking lot P1 is provided, and the processes of steps S505 and S506 may be omitted.

In step S509, the control unit 120 determines whether the vehicle C1 is temporarily stopped based on the vehicle information acquired by the vehicle information acquisition unit 150. When the vehicle C1 is traveling, the process proceeds to step S510. On the other hand, when the vehicle C1 is temporarily stopped, the process proceeds to step S511.

In step S510, the control unit 120 causes the speech output unit 220 to output speech information based on the character information acquired in step S503. In this manner, in the example illustrated in FIG. 11, when the vehicle C1 is traveling, the facility guidance is executed using only the speech information of the character without displaying the character image unrelated to the driving of the vehicle C1. However, a character image in a still state without movement may be displayed. When the speech information of the character is output, the speech information is continuously output. When a character image with a movement is displayed, the movement of the character image may be stopped and a still image may be continuously output.

In step S511, the control unit 120 causes the display unit 210 to display the character image based on the character information acquired in step S503, and causes the speech output unit 220 to output speech information. In this manner, in the example illustrated in FIG. 11, when the vehicle C1 is stopped, the character image that can be viewed by the user U1 of the vehicle C1 is displayed, and the facility guidance is executed using the character image and the speech information of the character. In this case, it is possible to display a character image in an operation state with a movement. When a character image of a still image is displayed, the character image may be displayed as the image with a movement. When the speech information of the character is output, the speech information may be continuously output.

In step S512, it is determined whether the vehicle C1 is parked in a parking location of a guidance destination. That is, it is determined whether parking of the vehicle C1 is completed and the vehicle C1 is in a parked state at a parking location of a guidance destination. The parking location of the guidance destination may be acquired based on the facility route information acquired in step S503. Whether the vehicle C1 moves to the parking location of the guidance destination may be determined based on the positional information acquired by the positional information acquisition unit 140. Whether the vehicle C1 is parked at the parking location of the guidance destination may be determined based on the vehicle information acquired by the vehicle information acquisition unit 150, for example, the speed. When the vehicle C1 is parked at the parking location of the guidance destination, the process proceeds to step S513. On the other hand, when the vehicle C1 is not parked at the parking location of the guidance destination, the process returns to step S505.

In step S513, the control unit 120 ends the facility information output process. In this case, the facility guidance process may be executed from when the vehicle C1 is parked at the parking location of the guidance destination to when the vehicle C1 is turned off. For example, the display screens 440, 450, and 460 illustrated in FIGS. 8 to 10 may be sequentially displayed, or the speech information S4 to S6 may be sequentially output.

In the above, an example is shown in which the output process is executed using the facility information received in step S503. However, the facility information as an output target may be determined on the vehicle C1 side, the control unit 120 may request the necessary facility information from the facility server 300 based on the determination result, and the control unit 120 may execute the output process using the facility information sequentially acquired from the facility server 300.

### Output Example of Facility Information when Vehicle Leaves Facility

Next, output examples of the facility information when the vehicle C1 leaves the ABC facility 350 will be described.

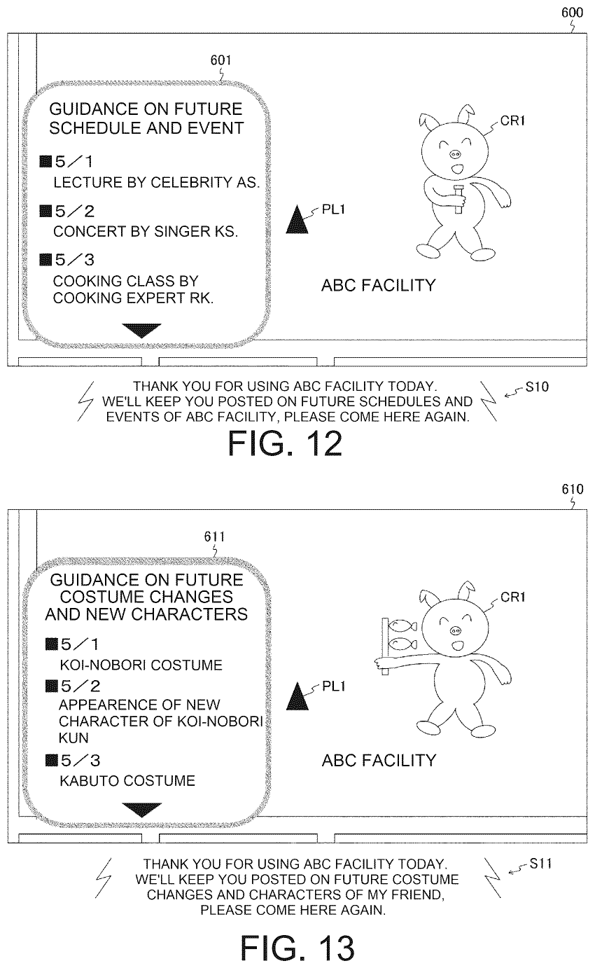

FIGS. 12 to 15 are diagrams illustrating output examples of the facility information output from the output unit 200 when the vehicle C1 leaves the ABC facility 350. FIGS. 12 to 15 illustrate display screens 600, 610, 620, and 630 on which the current location sign PL1 is superimposed and displayed on the map as in FIGS. 5 to 10. FIG. 12 illustrates an example when the vehicle C1 is turned on in the parking lot P1 (see FIG. 3) of the ABC facility 350. In this manner, when the vehicle C1 is turned on, the information processing device 100 of the vehicle C1 starts communication with the facility server 300 and receives the facility information from the facility server 300. Then, the information processing device 100 starts the output process of the output unit 200 based on the facility information received from the facility server 300.

FIG. 12 illustrates, together with the character image CR1, the display screen 600 for displaying a future schedule related to the ABC facility 350 and a future event in the ABC facility 350 in a facility guidance area 601, and the speech information S10. At least one of the future schedule related to the ABC facility 350 and the future event in the ABC facility 350 may be displayed in the facility guidance area 601. In this manner, it is possible to provide future information of the ABC facility 350 such as a schedule or an event of the ABC facility 350 at a timing when the vehicle leaves the ABC facility 350, for example, in a time zone in which the route guidance information is not output.

FIG. 13 illustrates, together with the character image CR1, the display screen 610 for displaying a costume change schedule of a character and an appearance schedule of a new character in a character scheduled area 611, and the speech information S11. At least one of the costume change schedule of the character and the appearance schedule of a new character may be displayed in the character scheduled area 611. In this manner, it is possible to provide guidance on the costume change schedule of the character and the appearance schedule of a new character at a timing when the vehicle leaves the ABC facility 350, for example, in a time zone in which the route guidance information is not output.

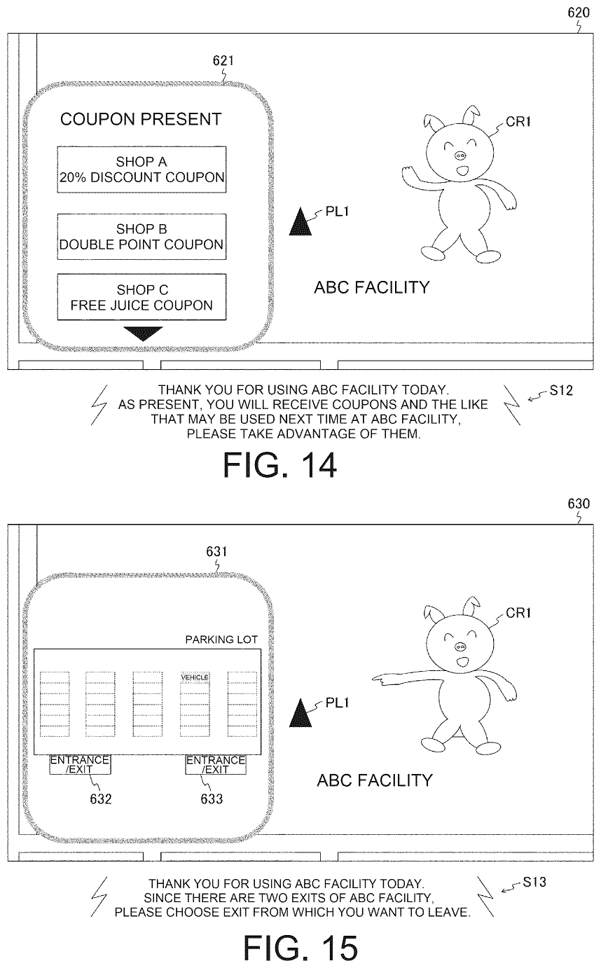

FIG. 14 illustrates, together with the character image CR1, the display screen 620 including a preferential treatment guidance area 621 capable of acquiring various types of preferential treatment information such as coupons, points, and discount tickets that may be used next time in the ABC facility 350, and the speech information S12. For example, the user U1 may acquire desired preferential treatment information by pressing a preferential treatment button in the preferential treatment guidance area 621.

FIG. 15 illustrates, together with the character image CR1, the display screen 630 including an entrance/exit selection area 631 for selecting the entrances/exits DW1 and DW2 of the ABC facility 350, and the speech information S13. For example, the user U1 presses a desired entrance/exit button between entrance/exit buttons 632 and 633 displayed in the entrance/exit selection area 631, so that route guidance to the desired entrance/exit in the parking lot of the ABC facility 350 is started.

The output examples illustrated in FIGS. 12 to 15 are examples, and other outputs may be performed, or only some of the outputs may be output. For example, in the case of a facility with one entrance/exit, the output of the display screen 630 and the speech information S13 illustrated in FIG. 15 can be omitted. The output of the display screen 630 and the speech information S13 illustrated in FIG. 15 may be started immediately after the vehicle C1 is turned on, and the outputs illustrated in FIGS. 12 to 14 may be sequentially performed after the entrance/exit selection operation is completed.

The outputs illustrated in FIGS. 12 to 15 may be output at any timing from when the vehicle C1 is turned on to when the vehicle C1 leaves the entrance/exit DW1 or DW2 of the ABC facility 350.

### Operation Example of Information Processing Device

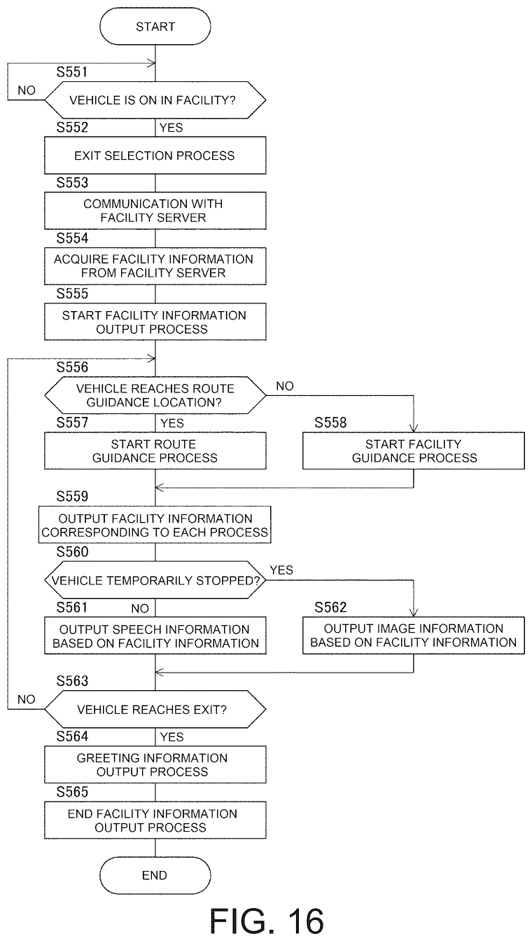

FIG. 16 is a flowchart illustrating an example of the facility information output control process in the information processing device 100. The output control process is executed based on a program stored in the storage unit 130. In addition, the output control process is always executed at each control cycle after the vehicle C1 is parked in the parking lot P1 of the ABC facility 350 and is turned off. The output control process will be described with reference to FIGS. 1 to 15 as appropriate.

In step S551, the control unit 120 determines whether the vehicle C1 is turned on in the parking lot P1 of the ABC facility 350 based on the vehicle information acquired by the vehicle information acquisition unit 150. When the vehicle C1 is turned on in the parking lot P1, the process proceeds to step S552. On the other hand, when the vehicle C1 is not turned on in the parking lot P1, the monitoring is continued.

In step S552, the control unit 120 executes an exit selection process. For example, the control unit 120 causes the display unit 210 to display the display screen 630 illustrated in FIG. 15, and executes the exit selection process for causing the user U1 to select a desired entrance/exit in the entrance/exit selection area 631. Since the ABC facility 350 includes two entrances/exits DW1 and DW2, the exit selection process is executed, but for a facility with one entrance/exit, guidance to one entrance/exit can be started without executing the exit selection process.

It is also assumed that the user U1 sets a destination in a navigation device installed in the vehicle C1 immediately after the vehicle C1 is turned on. In this case, the control unit 120 may acquire the destination set in the navigation device from the navigation device, and automatically select the entrance/exit toward the destination, that is, the entrance/exit heading the destination.

Since processes illustrated in steps S553 to S562 correspond to processes illustrated in steps S502 to S511 illustrated in FIG. 11, description thereof is omitted here. However, an output content when the vehicle C1 enters the ABC facility 350 may be different from an output content when the vehicle C1 leaves the ABC facility 350, as illustrated in FIGS. 12 to 15.

In step S563, the control unit 120 determines whether the vehicle C1 arrives at the entrance/exit DW1 or DW2 selected in step S552. Whether the vehicle C1 arrives at the entrance/exit DW1 or DW2 may be determined based on the positional information acquired by the positional information acquisition unit 140. When the car navigation device of the vehicle C1 can recognize a general public road, it may be determined that the vehicle C1 arrives at the entrance/exit DW1 or DW2. When the vehicle C1 arrives at the entrance/exit DW1 or DW2, the process proceeds to step S564. On the other hand, when the vehicle C1 neither arrives at the entrance/exit DW1 nor DW2, the process returns to step S556.

In step S564, the control unit 120 executes a greeting information output process. For example, a greeting message for goodbye is output by speech together with the display of the character image CR1 that is crying for goodbye. A future event of the ABC facility 350, schedule information such as new storefront information of the ABC facility 350, guidance on a schedule of changing the costume of the character (costume changing), and the like may be provided based on the facility information acquired in step S554, and inducement information on visit to the ABC facility 350 in the near future may be provided. For example, the display screens 600, 610, and 620 illustrated in FIGS. 12 to 14 may be sequentially displayed, or the speech information S10 to S12 may be sequentially output.

In step S565, the control unit 120 ends the facility information output process. The facility guidance process may be executed for a predetermined time after the vehicle C1 passes through the entrance/exit DW1 or DW2. For example, the speech information S10 to S12 illustrated in FIGS. 12 to 14 may be sequentially output.

Here, for example, it is assumed that when the vehicle C1 enters the ABC facility 350, the navigation device of the vehicle C1 does not provide guidance on the entrances/exits DW1 and DW2. Here, since guidance on the entrances/exits DW1 and DW2 is provided when the vehicle C1 enters the ABC facility 350, it is preferable to start the facility information output process with reference to the predetermined range RG1 on the front side of the entrances/exits DW1 and DW2.

On the other hand, when the vehicle C1 leaves the ABC facility 350, the navigation device of the vehicle C1 often performs route guidance from the entrances/exits DW1 and DW2. Therefore, when the vehicle C1 leaves the ABC facility 350, the facility information output process may end with reference to the entrances/exits DW1 and DW2. However, after the greeting information is output with reference to the entrances/exits DW1 and DW2, future event information may be output or another piece of facility guidance information may be output. That is, the facility information output process may be ended with reference to a predetermined range after passing through the entrances/exits DW1 and DW2.

### Example in which Facility Information is Changed based on Visit History of Vehicle

In the above, an example is shown in which the same facility information is provided to each of vehicles that enter the ABC facility 350. Here, among users who come to the ABC facility 350, there are a user who comes to the ABC facility 350 for the first time and a user who comes to the ABC facility 350 for a plurality of times. For example, when the same facility information as that for the user who comes to the ABC facility 350 for the first time is provided to a user A1 who comes to the ABC facility 350 for a plurality of times, the user A1 may be tire of the facility information, and the interest in the ABC facility 350 may decrease. Hereinafter, an example in which the facility information is changed based on the visit history of the vehicle will be described.

### Functional Configuration Example of Facility Server

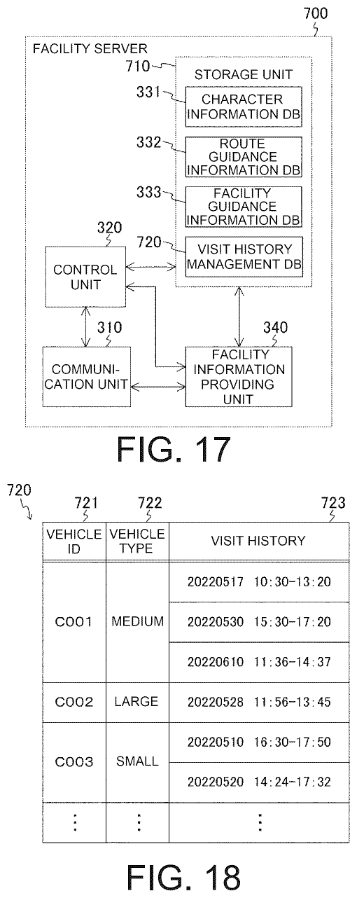

FIG. 17 is a block diagram illustrating a functional configuration example of a facility server 700. The facility server 700 is the same as the facility server 300 illustrated in FIG. 2 except that a storage unit 710 is provided instead of the storage unit 330 in the facility server 300. Therefore, differences from the facility server 300 will be mainly described here.

The facility server 700 includes the storage unit 710. A visit history management DB 720 is stored in the storage unit 710. The visit history management DB 720 will be described in detail with reference to FIG. 18.

### Storage Content Example of Visit History Management DB

FIG. 18 is a simplified diagram illustrating storage contents of the visit history management DB 720 stored in the storage unit 710.

The visit history management DB 720 is a database for managing vehicles arriving at the ABC facility 350 (see FIG. 3). Specifically, a vehicle type 722 and a visit history 723 are stored in the visit history management DB 720 in association with a vehicle ID 721. “C001” of the vehicle ID 721 corresponds to the vehicle C1 (see FIG. 1). The vehicle ID 721 may use vehicle identification information described later or information different from the vehicle identification information.

The vehicle type 722 is information related to the type of the vehicle. For example, the model number of the vehicle, the size of the vehicle, and the color of the vehicle are stored as the vehicle type information. FIG. 18 illustrates an example in which the size of the vehicle is stored as the vehicle type 722.

The size of the vehicle is used to determine the parking space of each vehicle in the parking lot P1 of the ABC facility 350, for example. For example, when a parking space dedicated to a light automatic vehicle is present in the parking lot P1 of the ABC facility 350, only a “small” vehicle as the vehicle type 722 may be placed in the parking space dedicated to a light automatic vehicle. In addition, for example, when a parking space dedicated to a large automatic vehicle is present in the parking lot PI of the ABC facility 350, it is possible to place “large” to “small” vehicles as the vehicle type 722 in the parking space dedicated to a large automatic vehicle. However, in this case, it is preferable to preferentially place a “large” vehicle as the vehicle type 722.

The color of the vehicle is used, for example, when some image is formed by a plurality of vehicles in the parking lot P1 of the ABC facility 350. For example, a character “one” may be formed by arranging vehicles of the same color in a row. When a plurality of vehicles are parked in the parking lot P1 of the ABC facility 350, in a case where vehicles with the same color are adjacent to each other, it is assumed to be difficult for each user to find his/her own vehicle. Therefore, for example, an arrangement is made such that vehicles with the same color are not adjacent to each other or vehicles with the same color are not parked to be close, so that each user may easily find his/her own vehicle.

The vehicle type information may be determined based on an image of the vehicle, which is acquired by capturing the appearance of the vehicle. A known image recognition technique can be adopted as the determination method. The vehicle type information may be registered in advance by a user who uses the facility information providing service.

The visit history 723 is history information indicating a history of arrival at the ABC facility 350 (see FIG. 3). For example, the date and time of entering the parking lot P1 of the ABC facility 350 and the date and time of leaving the parking lot P1 are stored as the history information. For example, date and time from the date and time when the facility information is transmitted at the time of entering the parking lot P1 to the time of leaving the parking lot P1 may be stored as the history information. A past parking position in the parking lot P1 may be stored as the history information, or a purchase history at each shop of the ABC facility 350 may be stored as the history information. Accordingly, it is possible to grasp in which area in the ABC facility 350 the user of each vehicle parks and which area is frequently used.

In this manner, the visit history of each vehicle is managed on a facility server 700 side, so that it is possible to grasp the frequency of arrival of vehicles entering the ABC facility 350 and which area in the ABC facility 350 is used. Therefore, the facility server 700 may transmit facility information matched with the user of each vehicle. Accordingly, the ABC facility 350 may provide advertising strategy information. In addition, it is possible to provide a service having an advantageous condition to a user who frequently uses the ABC facility 350. For example, it is possible to provide a preferential parking space or a parking space close to an area that is frequently used.

These pieces of information illustrated in FIG. 18 are examples, and only a part of these pieces of information may be stored in the visit history management DB 720, or another piece of information may be stored in the visit history management DB 720.

### Identification Example of Vehicle

Here, an identification method for identifying a vehicle entering the parking lot P1 (see FIG. 3) of the ABC facility 350 will be described. As vehicle identification information (or vehicle specific information) for identifying a vehicle, information capable of uniquely specifying each vehicle such as a license plate of the vehicle, a vehicle body number, and device identification information (for example, media access control (MAC) address) of a communication device (for example, network device) installed in the vehicle can be used. The license plate of the vehicle and the vehicle body number may be acquired based on the image of the vehicle which is acquired by capturing the appearance of the vehicle. A known image recognition technique can be adopted as the acquisition method. The device identification information may be acquired through wireless communication between the facility server 300 and the communication device of each vehicle.

It is also possible to issue a unique ID from the facility server 300 at the time of entering the parking lot P1 of the ABC facility 350 for the first time, and use the unique ID as the vehicle identification information for identifying the vehicle. For example, a card-type ID is issued to the user of the vehicle as the unique ID, and every time the user enters the parking lot P1 of the ABC facility 350, the device of the ABC facility 350 is caused to read the information of the card and an ID of the card is transmitted to the facility server 300. In addition, as the unique ID, for example, ID information is transmitted to a communication device of the vehicle and stored in a storage unit of the communication device, and every time the vehicle enters the parking lot PI of the ABC facility 350, the ID information in the storage unit is transmitted to the facility server 300. In this manner, each vehicle holds a unique ID issued to each vehicle, and it is also possible to use the unique ID at the time of subsequent access to the ABC facility 350.

For example, the communication unit 110 of the information processing device 100 functions as an information transmitting/receiving unit that exchanges the vehicle identification information for identifying the vehicle Cl with the facility server 300.

Although FIGS. 17 and 18 illustrate an example in which the visit history of the vehicle is managed in the facility server 700, the visit history may be managed on the vehicle side. In this case, every time the vehicle enters the ABC facility 350, it is necessary to transmit information related to the visit history managed on the vehicle side to the facility server 700. On the other hand, when the visit history of the vehicle is managed in the facility server 700, the exchange of the information related to the visit history becomes unnecessary, and thus the exchange of the information is reduced and the processing load can be reduced. In addition, the facility server 700 can easily perform control, on the vehicle, for determining which facility information is to be transmitted to the vehicle.

### Output Example of Facility Information

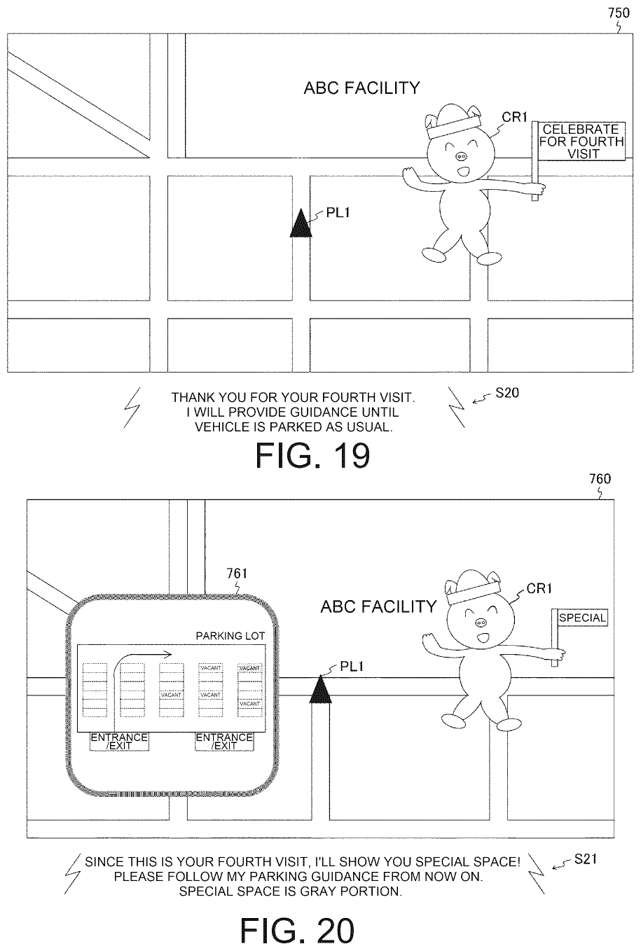

FIGS. 19 and 20 are diagrams illustrating output examples in a case where the facility information is output from the output unit 200 when the vehicle C1 enters the ABC facility 350. The output example illustrated in FIG. 19 is obtained by partially modifying the output example illustrated in FIG. 5, and the output example illustrated in FIG. 20 is obtained by partially modifying the output example illustrated in FIG. 6. Therefore, hereinafter, description of portions common to the output examples illustrated in FIGS. 5 and 6 will be omitted, and portions different from the output examples illustrated in FIGS. 5 and 6 will be mainly described. As described above, the vehicle Cl arrives at the ABC facility 350 three times in the past. Therefore, FIGS. 19 and 20 illustrate output examples when the vehicle C1 arrives at the ABC facility 350 for a fourth time.

FIG. 19 illustrates a display screen 750 on which the character image CR1 is superimposed and displayed on a map, and the speech information S20. When the vehicle C1 enters the ABC facility 350 for the fourth time, it is possible to change the character image CR1 to a display mode indicating that the vehicle C1 arrives four times and to change the speech information S20 to a content indicating that the vehicle C1 arrives four times. In this manner, the way and contents of providing the information of the character change according to the number of visits, and thus it is possible to provide the inducement information for the purpose of increasing the number of visits.

FIG. 20 illustrates, together with the character image CR1, a display screen 760 on which a guidance display area 761 for providing guidance on the route of the parking lot P1 of the ABC facility 350 is superimposed and displayed on the map, and the speech information S21.

In the guidance display area 761, the overall configuration and the route of the parking lot P1 of the ABC facility 350, the presence or absence of parking in each parking space and the like are displayed. When the vehicle C1 enters the ABC facility 350 for the fourth time, it is possible to change the character image CR1 to a display mode indicating that the vehicle C1 arrives four times or change the speech information S21 to a content indicating that the vehicle C1 arrives four times, similarly to FIG. 19. In addition, it is possible to preferentially assign a position that is easy to enter each shop of the ABC facility 350 as the parking space of the vehicle C1 according to the number of visits to the ABC facility 350. In this manner, since it is possible to receive priority assignment according to the number of visits, it is possible to provide the inducement information for the purpose of increasing the number of visits.

In this manner, it is possible to select a new event, new shop information, facility information that is not guided, and the like based on the number of past visits of the vehicle C1 (or occupant thereof) and the past visit timing, and provide the user U1 of the vehicle C1 with the selected information. In addition, it is possible to change a guidance content, a greeting word, phraseology, endings, and the like of the character based on the number of visits of the ABC facility 350, a visit interval from the previous visit, and the like, and to provide the above to the user U1 of the vehicle C1.

For example, for a user of a vehicle which arrives at the ABC facility 350 for the first time, an output content for self-introduction of the character or the like can be used together with speech information such as welcome. For a user of a vehicle which arrives at the ABC facility 350 for a plurality of times, the greeting way of the character and the behavior of the character are changed according to the number of visits. For example, it is possible to make the phraseology of the character slightly flank or make the movement of the character friendly according to an increase in the number of arrivals to the ABC facility 350. In addition, for a user of a vehicle which arrives at the ABC facility 350 for the first time, it is possible to predict the next visit by greeting with “Please come here again” at the timing of leaving the ABC facility 350.

### Operation Example of Information Processing Device and Facility Server

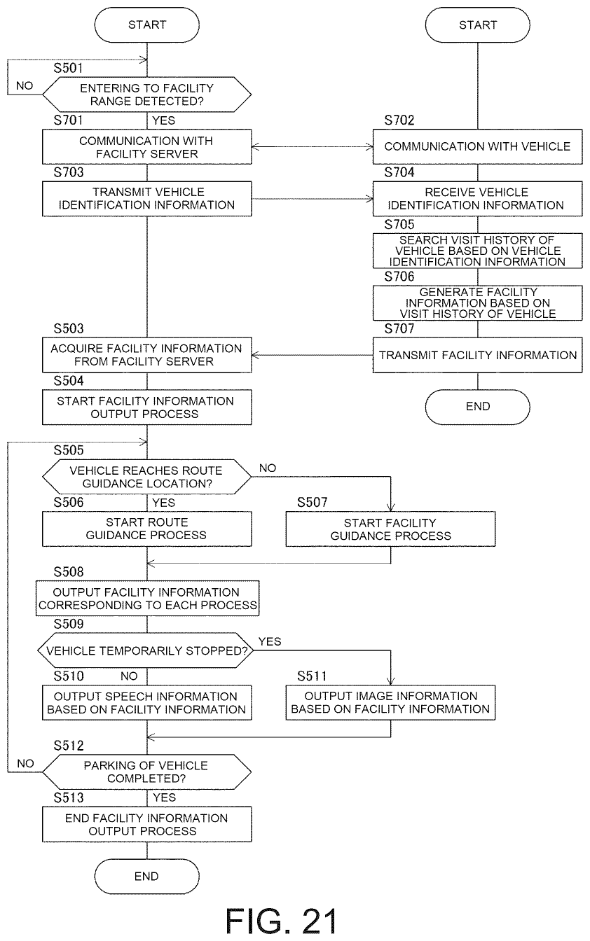

FIG. 21 is a flowchart illustrating an example of the facility information output control process in the information processing device 100 and the facility server 700. The output control process in the information processing device 100 is executed based on a program stored in the storage unit 130. The output control process in the facility server 700 is executed based on a program stored in the storage unit 710. The output control process is always executed in each control cycle. The output control process will be described with reference to FIGS. 1 to 20 as appropriate.

The output control process is obtained by modifying a part of the output control process illustrated in FIG. 11. Specifically, a difference therebetween is that in communication between the information processing device 100 and the facility server 700, the vehicle identification information of the vehicle C1 is transmitted to the facility server 700, and the facility information corresponding to the visit history of the vehicle C1 is transmitted to the information processing device 100. Since other points are the same as those of the output control process illustrated in FIG. 11, the same reference numerals as those in FIG. 11 are given and the description thereof is omitted.

In steps S701 and S702, the communication between the information processing device 100 and the facility server 700 is started.

In step S703, the control unit 120 transmits the vehicle identification information of the vehicle C1 to the facility server 300. In this example, device identification information (for example, MAC address) is used as the vehicle identification information.

In step S704, the communication unit 310 of the facility server 700 receives the vehicle identification information transmitted from the information processing device 100.

In step S705, the facility information providing unit 340 of the facility server 700 searches the visit history management DB 720 based on the vehicle specific information received in step S704. Then, the control unit 320 acquires the vehicle type 722 of the vehicle C1 “medium” and the visit history 723 “visited three times in the past”.

In step S706, the facility information providing unit 340 of the facility server 700 generates facility information to be provided to the vehicle C1 based on the visit history of the vehicle C1 acquired from the visit history management DB 720. Specifically, since the vehicle type 722 of the vehicle C1 is “medium”, the facility information providing unit 340 assigns, to the vehicle C1, a vacant space in which a medium-sized vehicle may be parked among vacant spaces of the parking lot P1 (see FIG. 3). Then, the facility information providing unit 340 generates route guidance information for providing the vehicle C1 with guidance to the assigned vacant space. Since the visit history 723 of the vehicle C1 is “visited three times in the past”, the facility information providing unit 340 generates route guidance information and facility guidance information to be provided to a fourth visitor. For example, route guidance information and facility guidance information as the output contents illustrated in FIGS. 19 and 20 are generated.

In step S707, the facility information providing unit 340 of the facility server 700 transmits the facility information generated in step S706 to the information processing device 100 via the communication unit 310.

In this manner, since the visit history management DB 720 may be managed on the facility server 700 side and the facility information corresponding to the vehicle may be generated on the facility server 700 side, it is unnecessary to particularly change the process according to the number of visits on the vehicle side. Therefore, coping is possible only by subjecting, on the vehicle side, the facility information transmitted from the facility server 700 to an output process at the position of the vehicle or at a predetermined timing.

Although FIG. 21 illustrates an example of the output process when the vehicle C1 enters the ABC facility 350, the facility information corresponding to the vehicle C1 is similarly generated on the facility server 700 side and transmitted to the vehicle C1 when the vehicle C1 leaves the ABC facility 350.

As described above, when the vehicle C1 enters the ABC facility 350, it is possible to execute a performance in which the character of the ABC facility 350 greets. On the other hand, when the vehicle C1 leaves the ABC facility 350, it is possible to execute a performance that the character of the ABC facility 350 is sad.

Here, when a relatively large facility is set as the destination, it is possible to display and use a route to the facility using a car navigation device. However, in the car navigation device, the route guidance ends at a timing when the vehicle arrives at the facility. That is, it is impossible to provide guidance on a route after the vehicle enters the facility. However, when the parking lot of the facility is wide, it is difficult to easily grasp where to proceed after entering the facility. Therefore, in the present embodiment, when the vehicle C1 enters the ABC facility 350, route guidance on the parking lot P1 of the ABC facility 350 and the like is provided.

In addition, it is impossible to provide the user U1 of the vehicle C1 with description, guidance, and the like of each shop in the ABC facility 350 only by providing route guidance on the parking lot P1 of the ABC facility 350 and the like after the vehicle C1 enters the ABC facility 350. Therefore, there is a possibility that expectation of the user U1 cannot be increased by a consistent image of the ABC facility 350.

Therefore, in the present embodiment, the facility guidance information on the ABC facility 350 is output and provided to the user U1 together with the route guidance information of the ABC facility 350. In addition, each guidance in the ABC facility 350 is executed by a character that can recall an image of the ABC facility 350.

In this manner, the guidance in the ABC facility 350 is provided by a unified character, so that the expectation of the user U1 can be increased by a consistent image of the ABC facility 350. When the user U1 arrives at the ABC facility 350, it is possible to convert a daily state to an extraordinary state (world of facility) and cause the user to be interested in the facility. Since marketing using a character can be started from a timing of riding in the vehicle C1, attraction, branding, and the like to a target outside an original range becomes possible.

In this manner, in the present embodiment, since guidance can be provided using the character of the ABC facility 350 at the time of providing the route guidance or the facility guidance in the ABC facility 350, it is possible to provide guidance with an advertising effect by a unified image before using the facility.

Since the guidance is executed using display of a still image of a character and speech output of the character while the vehicle C1 is traveling, the user U1 of the vehicle C1 can concentrate on driving, and the driving can be appropriately executed.

Although an example in which the information acquisition process, the information output process, and the like are executed in the information processing device 100 has been described above, all or a part of the processes may be executed in another device. In this case, an information processing system is configured by each device that executes a part of each process. For example, the facility server 300, a device (for example, smartphone, tablet terminal, personal computer, car navigation device, and in-vehicle infotainment (IVI)) usable by the user U1, various information processing devices such as a server connectable via a predetermined network such as the Internet, and various electronic devices can be used to execute at least a part of each process.

For example, the information processing device 100 may sequentially transmit the vehicle information and the positional information to the facility server 300, and the facility server 300 may sequentially transmit only the facility information output from the information processing device 100 to the information processing device 100 based on the vehicle information and the positional information. In this case, the output process in the information processing device 100 is executed under the control of the facility server 300.

A part (or all) of the information processing system capable of executing functions of the information processing device 100 may be provided by an application that may be provided via a predetermined network such as the Internet. This application is, for example, software as a service (SaaS).

### Configuration Examples and Effects of Present Embodiment

The information processing device 100 is an information processing device capable of providing guidance on a route of the vehicle C1. The information processing device 100 includes the communication unit 110 (example of information acquisition unit) configured to acquire, when the vehicle C1 enters the predetermined range RG1 with reference to the ABC facility 350, route guidance information for providing guidance on the route of the vehicle C1 in the ABC facility 350, facility guidance information for providing guidance on predetermined information on each location in the ABC facility 350, and character information for outputting a character related to the ABC facility 350, the storage unit 130 configured to hold the route guidance information, the facility guidance information, and the character information, the positional information acquisition unit 140 configured to acquire positional information in the ABC facility 350, the output unit 200 configured to output various types of information, and the control unit 120 configured to cause the output unit 200 to output the character based on the character information, and cause the output unit 200 to output at least one of route guidance and facility guidance based on the route guidance information, the facility guidance information, and the positional information. For example, at least one of the route guidance and the facility guidance is displayed on the display unit 210 together with the character image CR1, as illustrated in FIGS. 5 to 10, 19, and 20. Speech information from the character is output from the speech output unit 220 as illustrated in FIGS. 5 to 10, 19, and 20.

With this configuration, when the vehicle C1 enters the ABC facility 350, route guidance for the parking lot P1 and the like and facility guidance for the ABC facility 350 may be output from the output unit 200 and provided to the user U1 together with the character related to the ABC facility 350. Accordingly, it is possible to provide more appropriate information corresponding to the ABC facility 350 to the user U1 who gets on the vehicle C1 and arrives at the ABC facility 350. That is, it is possible to provide an information processing device capable of providing, to a user, useful information related to a facility while enhancing interest of the user as much as possible at a timing of entering a predetermined range with reference to the facility. Further, for the user U1, it is possible to increase the expectation of the user U1 by a consistent image of the ABC facility 350, and to make the user U1 be interested in the ABC facility 350.

The information processing device 100 further includes the vehicle information acquisition unit 150 configured to acquire vehicle information related to the vehicle C1, which is information including whether the vehicle C1 is stopped. The output unit 200 includes the display unit 210 and the speech output unit 220. The control unit 120 determines whether the vehicle C1 is stopped based on the vehicle information, when the vehicle C1 is stopped, causes the display unit 210 to display the character image CR1 and executes at least one of the route guidance and the facility guidance using at least one of the character image CR1 and a speech of the character, and when the vehicle C1 is traveling, causes the speech output unit 220 to output the speech of the character without displaying the character image CR1 and executes at least one of the route guidance and the facility guidance using the speech of the character. When the vehicle C1 is traveling, at least one of the route guidance and the facility guidance may be executed by displaying the character image CR1 in the still state.

With this configuration, since the route guidance, the facility guidance, and the like may be executed without displaying the character image CR1 on the display unit 210 while the vehicle C1 is traveling, the user U1 of the vehicle C1 may drive the vehicle C1 without being aware of the character image CR1. That is, it is possible to provide an information processing device capable of effectively providing information at an appropriate timing.

The control unit 120 of the information processing device 100 causes the output unit 200 to output the character using, as the character information, at least a part of model data of the character, display information related to a display mode of the model data, operation instruction information related to an operation of the model data, and speech information related to the speech of the model data.

With this configuration, the facility server 300 provides information of various levels to the information processing device 100 as the character information, so that it is possible to change the character information to be used on the information processing device 100 side as necessary. For example, the character of the ABC facility 350 can provide all the guidance in the ABC facility 350. In addition, when an original character is present on the vehicle C1 side, it is possible to select two-dimensional character display, guidance display with a still image, or the like from a 3D character with a movement according to the guidance on the ABC facility 350 by causing the character to wear the costume for the ABC facility 350 or the performance or setting of the device on the vehicle C1 side.

The control unit 120 of the information processing device 100 changes an output mode of the character output from the output unit 200 according to the route guidance or the facility guidance output from the output unit 200. For example, the character image CR1 and the speech information from the character are changed as illustrated in FIGS. 5 to 10, 12 to 15, 19, and 20.

With this configuration, it is possible to change the output mode of the character to be used according to the information to be guided. Accordingly, it is possible to provide guidance to the user U1 in an easy-to-understand manner about the type of information to be guided and the relation therebetween.

The control unit 120 of the information processing device 100 causes the output unit 200 to output the route guidance in which the character is used at a timing when the vehicle C1 travels at a predetermined position in the ABC facility 350, and causes the output unit 200 to output the facility guidance in which the character is used at a timing when the vehicle C1 travels at a position other than the predetermined position.

With this configuration, the facility guidance can be provided during the route guidance, and thus it is possible to prioritize the route guidance related to the movement of the vehicle C1 and to provide the facility guidance or the like at another timing.

The communication unit 110 (example of information acquisition unit) of the information processing device 100 acquires facility guidance information including schedule information of the facility related to at least one of a future schedule related to the ABC facility 350 and a future event in the ABC facility 350, and the control unit 120 causes the output unit 200 to output, using the character at least one of the schedule and the event as the facility guidance at a timing when the vehicle C1 leaves the ABC facility 350. For example, a schedule and an event are displayed on the display unit 210 together with the character image CR1, and the speech information S10 from the character is output from the speech output unit 220, as illustrated in FIG. 12.

With this configuration, it is possible to provide guidance on the ABC facility 350 at the time of exiting from the ABC facility 350, and thus it is possible to provide inducement information for the next visit.

The communication unit 110 (example of information acquisition unit) of the information processing device 100 acquires character information including schedule information of the character related to at least one of a costume change schedule of the character and an appearance schedule of a new character, and the control unit 120 causes the output unit 200 to output, using the character, at least one of the costume change schedule of the character and the appearance schedule of the character as information related to the character at a timing when the vehicle C1 leaves the ABC facility 350. For example, the costume change schedule of the character and the appearance schedule of the character are displayed on the display unit 210 together with the character image CR1, and the speech information S11 from the character is output from the speech output unit 220, as illustrated in FIG. 13.

With this configuration, at the time of exiting from the ABC facility 350, it is possible to provide information on a change or an appearance schedule of a character used for each guidance, and it is possible to provide the information as induction information for the next visit.

The communication unit 110 (example of information acquisition unit) of the information processing device 100 acquires the character information for changing and outputting at least one of a guidance content using the character and the speech information of the character according to the number of times the vehicle C1 visits the ABC facility 350, and the control unit 120 changes and outputs an output mode of the character based on the number of times the vehicle C1 visits the ABC facility 350. For example, the output mode of the character may be changed, as illustrated in FIGS. 19 and 20.

With this configuration, the way and contents of information provision of the character change according to the number of visits, and thus it is possible to provide inducement information for the purpose of increasing the number of visits.

An information processing method according to the present embodiment is an information processing method capable of providing guidance on a route of the vehicle C1. The information processing method includes an information acquisition process (step S503) of acquiring, when the vehicle C1 enters the predetermined range RG1 with reference to the ABC facility 350, route guidance information for providing guidance on the route of the vehicle C1 in the ABC facility 350, facility guidance information for providing guidance on predetermined information on each location in the ABC facility 350, and character information for outputting a character related to the ABC facility 350, a storage process (step S503) of storing, in a storage unit, the route guidance information, the facility guidance information, and the character information, a positional information acquisition process (step S505) of acquiring positional information in the ABC facility 350, and a control process (steps S504 to S511) of causing the output unit 200 to output the character based on the character information and causing the output unit 200 to output at least one of route guidance and facility guidance based on the route guidance information, the facility guidance information, and the positional information. A program according to the present embodiment is a program for causing a computer to execute each process. In other words, the program according to the present embodiment is a program that causes a computer to implement each function executable by the information processing device 100.

With this configuration, when the vehicle C1 enters the ABC facility 350, route guidance for the parking lot P1 and the like and facility guidance for the ABC facility 350 may be output from the output unit 200 and provided to the user U1 together with the character related to the ABC facility 350. Accordingly, it is possible to provide more appropriate information corresponding to the ABC facility 350 to the user U1 who gets on the vehicle C1 and arrives at the ABC facility 350. That is, it is possible to provide an information processing method capable of providing, to a user, useful information related to a facility while enhancing interest of the user as much as possible at a timing of entering a predetermined range with reference to the facility. Further, for the user U1, it is possible to increase the expectation of the user U1 by a consistent image of the ABC facility 350, and to make the user U1 be interested in the ABC facility 350.

Each processing procedure described in the present embodiment is an example for implementing the present embodiment, and an order of a part of each processing procedure may be changed within the scope of implementing the present embodiment, or a part of each processing procedure may be omitted or other processing procedures may be added.

Each process described in the present embodiment is executed based on a program for causing a computer to execute each processing procedure. Therefore, the present embodiment can be understood as an embodiment of a program that implements a function of executing each process and a recording medium that stores the program. For example, the program can be stored in a storage device (storage medium) of the information processing device by performing an updating process for adding a new function to the information processing device. Accordingly, it is possible to cause the updated information processing device to execute each process described in the present embodiment.

Although the embodiment of the present invention has been described above, the above embodiment is merely a part of application examples of the present invention, and is not intended to limit the technical scope of the present invention to the specific configurations of the above embodiment.

The present application claims priority based on Japanese Patent Application No. 2022-117391 filed to the Japan Patent Office on Jul. 22, 2022, and the entire contents of this application are incorporated herein by reference.

1. An information processing device capable of providing guidance on a route of a vehicle, the device comprising:
an information acquisition unit configured to acquire, when the vehicle enters a predetermined range with reference to a facility, route guidance information for providing guidance on the route of the vehicle in the facility, facility guidance information for providing guidance on predetermined information on each location in the facility, and character information for outputting a character related to the facility;
a storage unit configured to hold the route guidance information, the facility guidance information, and the character information;
an output unit configured to output various types of information; and
a control unit configured to cause the output unit to output the character based on the character information, and cause the output unit to output at least one of route guidance and facility guidance based on the route guidance information and the facility guidance information, wherein
the control unit is configured to change an output mode of the character output from the output unit according to the route guidance or the facility guidance output from the output unit.

2. The information processing device according to claim 1, further comprising:
a vehicle information acquisition unit configured to acquire vehicle information related to the vehicle, the vehicle information being information including whether the vehicle is stopped, wherein
the output unit includes a display unit and a speech output unit, and
the control unit is configured to determine whether the vehicle is stopped based on the vehicle information, when the vehicle is stopped, cause the display unit to display an image of the character and executes at least one of the route guidance and the facility guidance using at least one of the image and a speech of the character, and when the vehicle is traveling, cause the speech output unit to output the speech of the character without displaying the image of the character and execute at least one of the route guidance and the facility guidance using the speech of the character.

3. The information processing device according to claim 1, wherein
the control unit is configured to cause causes the output unit to output the character by using, as the character information, at least a part of model data of the character, display information related to a display mode of the model data, operation instruction information related to an operation of the model data, and speech information related to a speech of the model data.

4. The information processing device according to claim 1, further comprising:
a positional information acquisition unit configured to acquire positional information in the facility, wherein
the control unit is configured to cause the output unit to output the route guidance in which the character is used at a timing when the vehicle travels at a predetermined position in the facility, and cause the output unit to output the facility guidance in which the character is used at a timing when the vehicle travels at a position other than the predetermined position.

5. The information processing device according to claim 1, wherein
the information acquisition unit is configured to acquire the facility guidance information including schedule information of the facility related to at least one of a future schedule related to the facility and a future event in the facility, and
the control unit is configured to cause the output unit, using the character, at least one of the schedule and the event as the facility guidance at a timing when the vehicle leaves the facility

6. The information processing device according to claim 1, wherein
the information acquisition unit is configured to acquire the character information including schedule information of the character related to at least one of a costume change schedule of the character and an appearance schedule of a new character, and
the control unit is configured to cause the output unit to output, using the character, at least one of the costume change schedule and the appearance schedule as information related to the character at a timing when the vehicle leaves the facility.

7. The information processing device according to claim 1, wherein
the information acquisition unit is configured to acquire the character information for changing and outputting at least one of a guidance content using the character and speech information of the character according to the number of times the vehicle visits the facility, and
the control unit is configured to change and output an output mode of the character based on the number of times the vehicle visits the facility.

8. An information processing method capable of providing guidance on a route of a vehicle, the method comprising:
an information acquisition process of acquiring, when the vehicle enters a predetermined range with reference to a facility, route guidance information for providing guidance on the route of the vehicle in the facility, facility guidance information for providing guidance on predetermined information on each location in the facility, and character information for outputting a character related to the facility;
a storage process of holding, in a storage unit, the route guidance information, the facility guidance information, and the character information; and
a control process of causing an output unit to output the character based on the character information, and causing the output unit to output at least one of route guidance and facility guidance based on the route guidance information and the facility guidance information, wherein
in the control process, an output mode of the character output from the output unit is changed according to the route guidance or the facility guidance output from the output unit.

9. A program for causing a computer to execute a route guidance process for providing guidance on a route of a vehicle, the program causing the computer to execute: An information processing method capable of providing guidance on a route of a vehicle, the method comprising:
an information acquisition process of acquiring, when the vehicle enters a predetermined range with reference to a facility, route guidance information for providing guidance on the route of the vehicle in the facility, facility guidance information for providing guidance on predetermined information on each location in the facility, and character information for outputting a character related to the facility;
a storage process of holding, in a storage unit, the route guidance information, the facility guidance information, and the character information; and
a control process of causing an output unit to output the character based on the character information, and causing the output unit to output at least one of route guidance and facility guidance based on the route guidance information and the facility guidance information, wherein
in the control process, an output mode of the character output from the output unit is changed according to the route guidance or the facility guidance output from the output unit.

10. (canceled)
